(19) United States
(12) Patent Application Publication
(10) Pub. No.: US 2010/0138054 A1
(43) Pub. Date: Jun. 3, 2010

(54) MICROPROCESSOR BASED JOCKEY PUMP CONTROLLER

(76) Inventor: Bruno GOUPIL, Beaconsfield (CA)

Correspondence Address: GOUDREAU GAGE DUBUC, 2000 MCGILL COLLEGE, SUITE 2200, MONTREAL, QC, H3A 3H3, CA

(21) Appl. No.: 12/626,718

(22) Filed: Nov. 27, 2009

Related U.S. Application Data
(60) Provisional application No. 61/118,029, filed on Nov. 26, 2008.

(51) Int. Cl. G05D 16/20; G05D 7/06; A62C 35/68

(52) U.S. Cl. 700/282; 169/13

(57) ABSTRACT

A microprocessor based jockey pump controller for controlling operation of a jockey pump used to maintain pressure within a fire pump system. The controller includes an electronic circuit board having a microprocessor mounted thereon, and a solid state pressure sensing device for monitoring a current level of the pressure. The sensing device is connected to the board for transmitting to the microprocessor an electrical signal indicative of the current level of the pressure. The microprocessor compares the received signal to predetermined pressure thresholds for selectively starting or stopping the jockey pump.

### CROSS REFERENCE TO RELATED APPLICATIONS

This application claims priority, under 35 U.S.C.§119(e), of U.S. provisional application Ser. No. 61/118,029, filed on Nov. 26, 2008, which is incorporated by reference in its entirety.

### FIELD OF THE INVENTION

The present invention relates to jockey pump controller manufacturing. In particular, the invention relates to the use of microprocessor and pressure transducer technologies in the manufacturing of jockey pump controllers.

### BACKGROUND OF THE INVENTION

As known in the art, current fire pump system standards require that every time a fire pump starts, a signal shall be sent to the alarm system of the building and the fire alarm triggered. In many instances, a fire pump in operation means the evacuation of the building and a call to the fire pump department. Thus, due to all the consequences associated with building evacuation, it is of prime importance to avoid any nonsense fire pump starts.

For this purpose, fire pump controllers are typically provided in fire pump systems to control operation of the fire pump by detecting a drop in system pressure, which typically indicates that a sprinkler head has been activated as a result of a fire. The fire pump controller then performs necessary sequential operations to activate the pump driver to pump water through the system. Jockey pump controllers are further used to automatically start and stop jockey pumps, which form an integral part of any fire pump assembly. Jockey pumps are typically small, motor driven pumps used in conjunction with main fire pumps to compensate for minor leaks in the fire protection system and automatically maintain stand-by pressure. Jockey pumps are also used to prevent the main fire pump from starting in the absence of a demand from the sprinkler system. A jockey pump installation thus reduces wear on the main pump and controller caused by unnecessary and frequent operation while preventing short cycling of the fire pump due to small leaks.

Currently, most fire pump controllers are microprocessor-based and use as pressure sensing transducers with high accuracy and precise adjustment of starting and stopping thresholds. However, a major drawback of jockey pump controllers presently on the market is that they are typically not available with such sensing technology. Instead, jockey pump controllers known in the art use electromechanical pressure switches, which are not accurate and are subject to fluctuations. Thus, it is not often that controllers as a whole unit can provide an accurate monitoring of pressure. As a result, the jockey pump in many occasions fails to start when called for, requiring the main fire pump to take over.

Another drawback of current jockey pump controller designs is the difficulty to visually verify pressure settings of the fire pump assembly. Indeed, operators have a hard time checking pressure settings as currently used electromechanical pressure switches are known to have a poor scale. As a result, such devices require a certain level of experience from the operator in order to be properly tuned. In particular, conventional controllers do not show the actual pressure at any time and pressure readings thus depend on externally-installed manometers, which are necessary to adjust pressure settings. It is thus apparent that failures of conventional jockey pump systems can easily go unnoticed as no data (e.g. pressure, settings, etc.) is available. In addition, current jockey pump controllers use electromechanical pressure switches without any independent cut-in and cut-out threshold settings points but instead with a set point and a differential adjustment having a large difference. This large difference prevents the pump from stopping exactly when desired in addition to potentially causing overpressure in the piping system.

What is therefore needed, and an object of the present invention, is an improved jockey pump controller, which allows for more accurate pressure adjustments and readings while simplifying installation and interaction between the controller and the operator.

### SUMMARY OF THE INVENTION

In order to address the above and other drawbacks, there is provided in accordance with the present invention a microprocessor based jockey pump controller for controlling operation of a jockey pump used to maintain pressure within a fire pump system. The controller comprises an electronic circuit board having a microprocessor mounted thereon and a solid state pressure sensing device for monitoring a current level of the pressure. The sensing device is connected to the board for transmitting to the microprocessor an electrical signal indicative of the current level of the pressure. The microprocessor compares the received signal to predetermined pressure thresholds for selectively starting or stopping the jockey pump.

In accordance with the present invention, there is also provided a microprocessor based jockey pump controller for controlling operation of a jockey pump used to maintain pressure within a fire pump system. The controller comprises an electronic circuit board having a microprocessor mounted thereon; and a solid state pressure sensing device for monitoring a current level of the pressure. The sensing device connected to the board for transmitting to the microprocessor an electrical signal indicative of the current level of the pressure. The microprocessor compares the received signal to predetermined pressure thresholds for selectively starting or stopping the jockey pump. The controller further comprises a first visual indicator for displaying the current level of the pressure and a second visual indicator for displaying the predetermined pressure thresholds.

### BRIEF DESCRIPTION OF THE DRAWINGS

In the appended drawings:

FIG. 1 is a schematic diagram of a prior art fire pump system;

FIG. 2 is a front perspective view of the front panel of a jockey pump controller in accordance with an illustrative embodiment of the present invention;

FIG. 3 is a front perspective view of the rear face of the access door of the jockey pump controller of FIG. 2;

FIG. 4 is a front perspective view of the interior of the housing of the jockey pump controller of FIG. 2;

FIG. 5 is a top perspective view of the populated circuit board of the jockey pump controller of FIG. 2;

FIG. 6 is a timing diagram showing operation of a jockey pump when the selector switch of a jockey pump controller is in the AUTO position in accordance with an illustrative embodiment of the present invention;

FIG. 7 is a timing diagram showing operation of a jockey pump when the selector switch of a jockey pump controller is in the OFF position in accordance with an alternative illustrative embodiment of the present invention; and

FIG. 8 is a timing diagram showing operation of the jockey pump when the selector switch of a jockey pump controller is in the HAND position in accordance with a further alternative illustrative embodiment of the present invention.

### DESCRIPTION OF ILLUSTRATIVE EMBODIMENTS

The present invention is illustrated in further details by the following non-limiting examples.

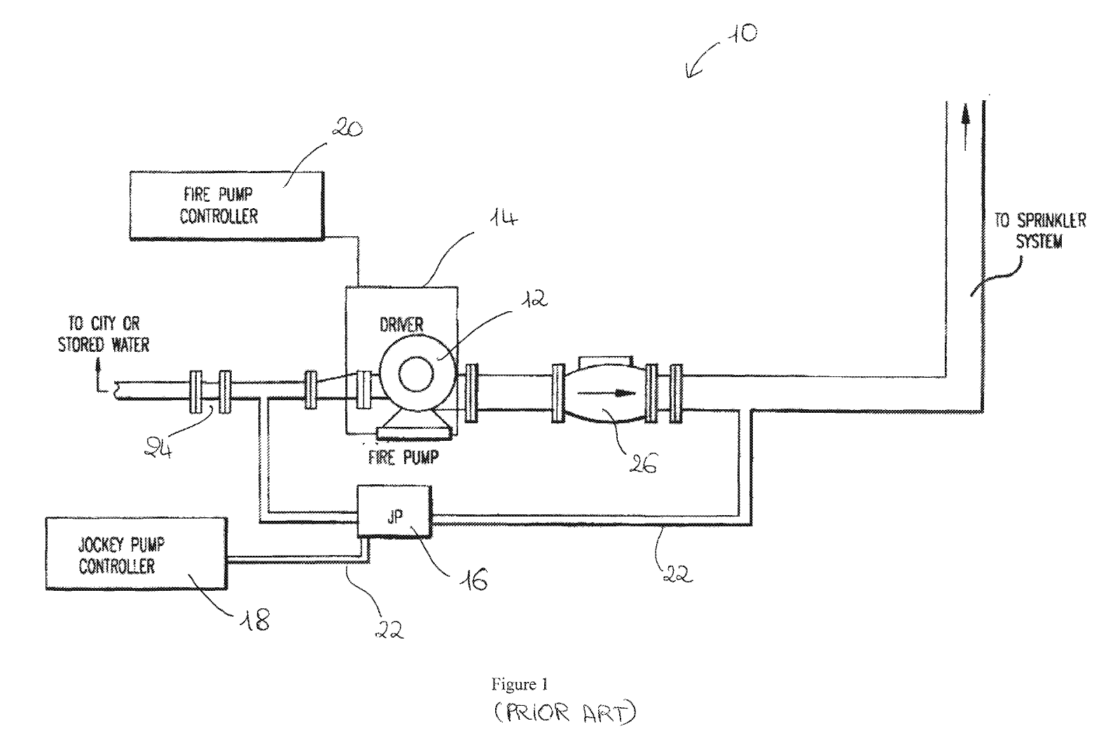

Referring now to FIG. 1, a fire pump system, generally referred to using the reference numeral 10, will now be described. The fire pump system 10 comprises a fire pump 12 illustratively having a rating between 5-400 horsepower (HP), a driver 14 (e.g. diesel or electric, with an electric driver shown in FIG. 1 for illustrative purposes only), a jockey pump 16 illustratively having a rating between 1-2 HP, a jockey pump controller 18, and a fire pump controller 20 all linked via piping as in 22 to provide and maintain a predetermined water pressure on a sprinkler system (not shown). The fire pump system 10 acts to supply and regulate water from a water supply (not shown) through a supply valve 24 and a check valve 26 to the sprinkler system, which has one or more discharge devices (not shown). The fire pump system 10 further maintains a predetermined system pressure by activation of the jockey pump 16, which is typically an electrically driven pump controlled by the independent jockey pump controller 18. Should a pressure loss that the jockey pump 16 cannot overcome occur, the fire pump 12 is then activated by the fire pump controller 20 to pump additional water from the water supply to the sprinkler system.

Still referring to FIG. 1, in order to ensure proper activation of the fire pump system 10 in the event of a fire to supply water to a desired location, and accordingly prevent malfunctioning thereof, a plurality of commercially available detectors and sensors (not shown) are illustratively provided at the driver 14 (to monitor current and voltage thereof) as well as at the fire pump 12, the jockey pump 16, the jockey pump controller 18, the fire pump controller 20, and the water supply valve 24 to control the water pressure, flow rate, starting of the pump and stopping of the pump. In particular, sensors are used to detect maintenance/problem information, such as the fire pump housing temperature, the pump bearing temperature, the position of the fire pump controller switch (not shown), and the open or closed position of the valve 24. A plurality of solid state pressure sensing devices or pressure transducers (not shown) are further illustratively provided at the fire pump 12 to measure for example the suction pressure at an inlet of the fire pump 12, the pump discharge pressure of the fire pump 12, the overall system pressure, and the like.

Still referring to FIG. 1, fire pump controllers as in 20 are typically provided in fire pump systems as in 10 to control operation of the fire pump 12 by detecting a drop in system pressure, which typically indicates that a sprinkler head (not shown) of the sprinkler system has been activated as a result of a fire. The fire pump controller 20 then performs necessary sequential operations to activate the pump driver 14 to pump water through the system 10. The controller 20 then maintains a predetermined volume of water and pressure to control or defeat the fire. Water leakage may however occur in the fire pump system 10 at flanged or threaded connections between the pipes as in 22, as well as at valve systems, stuffing boxes, etc, resulting in a gradual lowering of the system pressure until the main fire pump 12 is required to start. Jockey pumps as in 16 are thus used to minimize the wear on the fire pump 12 resulting from unnecessary operation thereof by automatically maintaining system pressure. In a jockey pump system 16, a small pump, motor, and controller/pressure switch unit 18 is installed in the piping system. The jockey pump pressure switch is set for approximately five (5) to ten (10) P.S.I.G. greater than the pressure switch for the main fire pump controller 20. When the water pressure drops below the pre-set level, the pressure switch thus energizes a starter which activates the jockey pump 16. In this manner, the jockey pump 16 as controlled by the jockey pump controller 18 keeps the system 10 at a predetermined pressure so that the fire pump 12 only runs when a fire occurs or the jockey pump 16 is overcome by a loss in system pressure. Correct water pressure is therefore maintained at all times.

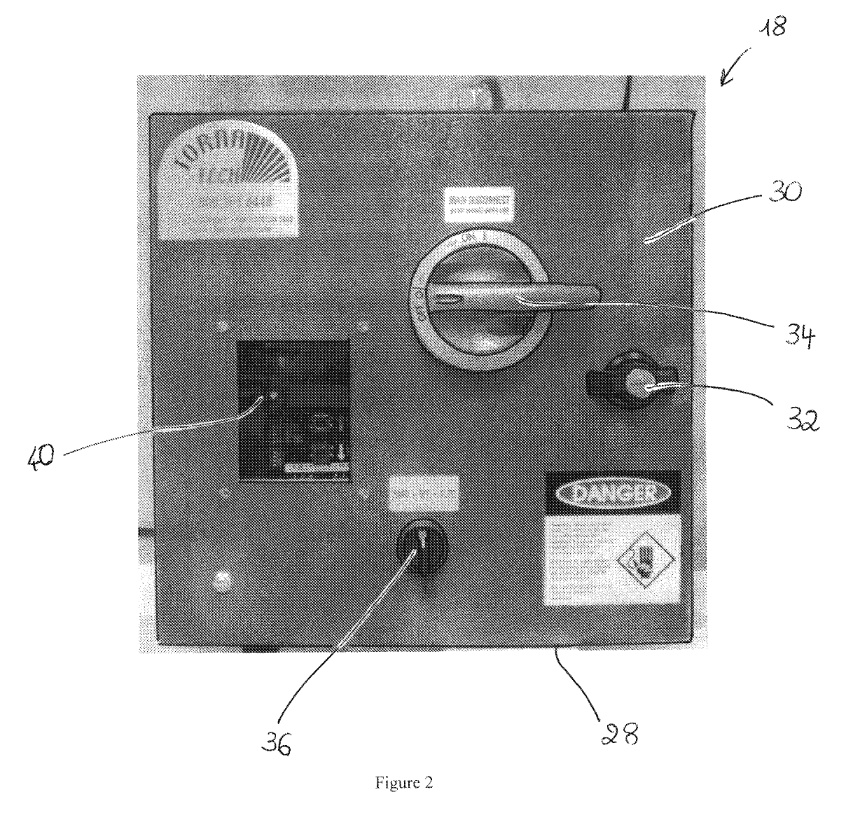

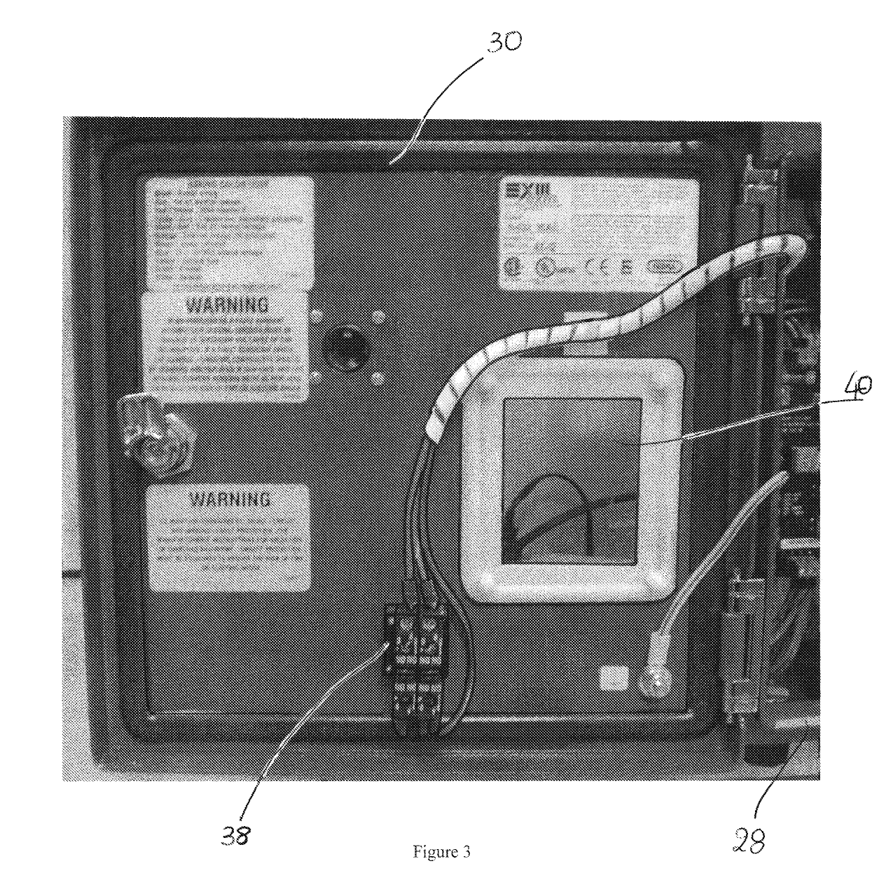

Referring now to FIG. 2 and FIG. 3, the jockey pump controller 18 of the present invention illustratively comprises a cabinet housing 28 (preferably constructed from fire resistant material) for retaining electronic system components (not shown) of the jockey pump controller 18 therein and an access door 30 hingedly mounted to a front face of the housing 28 for closing access to the system components for protection purposes. A suitable locking assembly 32 is illustratively provided on access door 30 to lock the latter and prevent unauthorized access to the system components. There is further mounted to the access door 30 a main disconnect handle 34 for manually disconnecting the jockey pump 16, a selector switch 36 having associated therewith selector switch contacts as in 38 mounted to a rear face of the access door 30 for selecting a mode of operation of the jockey pump 16, and a transparent window 40, which enables the operator to monitor specific parameters indicative of operation of the jockey pump 16.

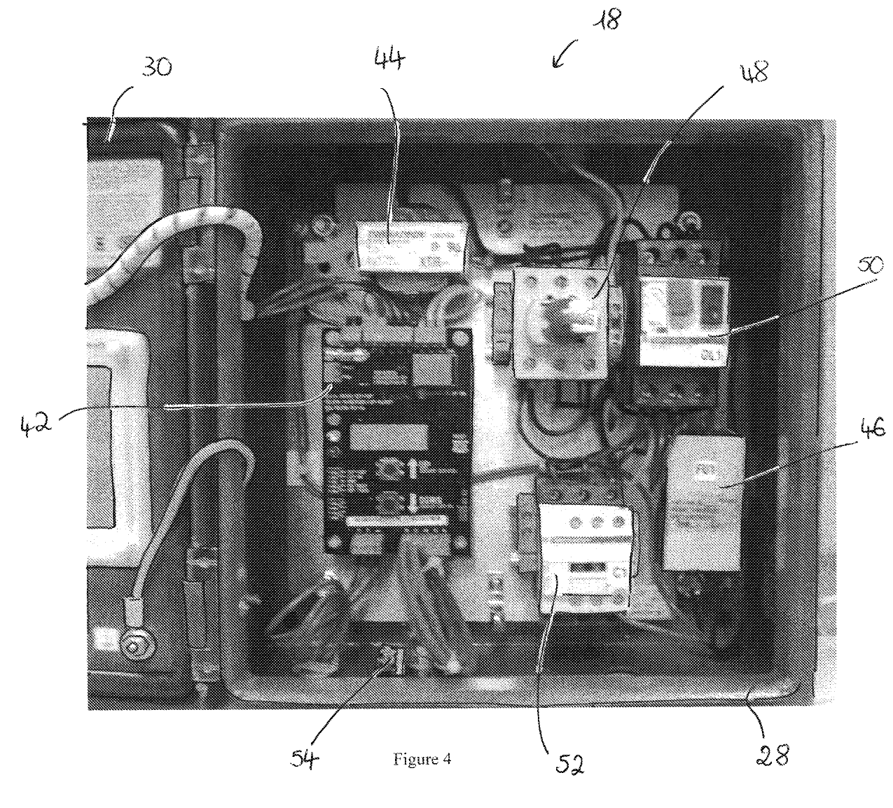

Referring now to FIG. 4, the jockey pump controller 18 is illustratively microprocessor based, i.e. assisted and controlled by a populated circuit board 42 having a built-in microprocessor (not shown) mounted thereon. The microprocessor (e.g. the MC9S08™ model from National Semiconductor), which is versatile and programmable by an external laptop (not shown), is implemented as a programmable control and timing relay used to give the pump-starting signal. The microprocessor further enables control and monitoring of the pressure of the fire pump system 10. For this purpose, an optional minimum run timer or delay may be included as part of the circuit board 42 to prevent the jockey pump (reference 16 in FIG. 1) from being started too frequently. For instance, the jockey pump controller 18 may be designed such that there is provided a delay before start to prevent nonsense starting of the jockey pump 16 in case of small pressure fluctuations as well as a delay before stop to prevent the jockey pump 16 from short cycling. Due to such an integrated delay on operate or on release, it is then possible to build up fully field adjustable and time-dependent pressure controls.

Still referring to FIG. 4, in addition to the circuit board 42 and built-in microprocessor, the jockey pump controller 18 further comprises a plurality of devices, all of which are interconnected and cooperate to ensure proper operation of the jockey pump (reference 16 in FIG. 1). In particular, the jockey pump controller 18 comprises a control transformer 44 (e.g. operating at 24 VAC) used to power the circuit board 42 and maximize output voltage regulation. The 24 VAC is illustratively changed to 5VDC with a conventional diode bridge and step down voltage regulator (not shown), such as the LM2591HV™ model from National Semiconductor. A primary fuse as in 46 is illustratively installed on the circuit board 42 for easy access and protects the transformer 44. A disconnect switch 48 is further provided to isolate the jockey pump controller 18 from the main power source, i.e. the driver 14, so that the equipment may be worked on safely as desired. The jockey pump controller 18 further comprises a motor protection device 50 (e.g. a circuit breaker) for protecting the driver 12 against overload, short circuits, faults in cables or wiring, phase failures, or the like as well as a motor contactor 52. A pressure transducer 54, is further used to convert pressure measurements into analog electrical signals for subsequent transmission to the microprocessor, as will be discussed further herein below.

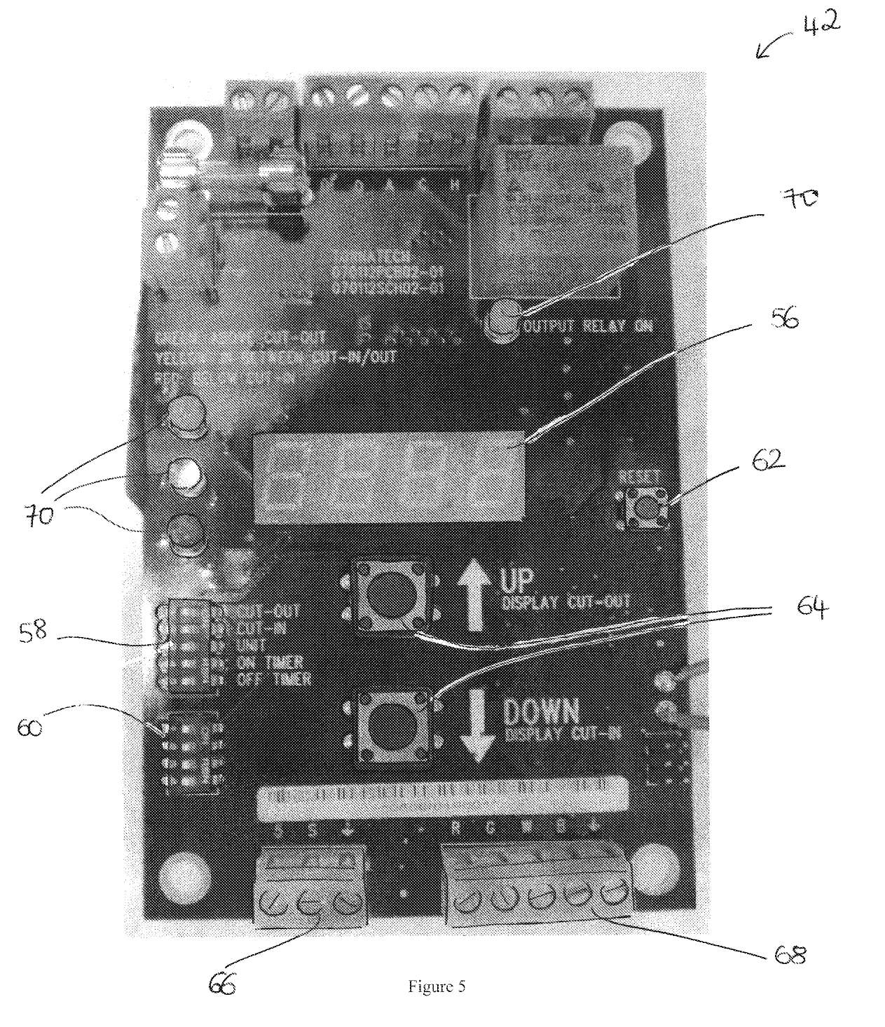

Referring now to FIG. 5 in addition to FIG. 4, the circuit board 42 has illustratively mounted thereon a four digit—seven segment display 56 driven by digital outputs of the circuit board 42, DIP switches (named according to their function) as in 58 for parameters setting and DIP switches as in 60 for calibration, a reset button 62 and UP/DOWN pushbuttons as in 64. The DIP switches as in 58 and 60 are illustratively used to connect the occasionally used digital inputs (not shown) to the circuit board 42 while the pushbuttons as in 64 illustratively connect the frequently used digital inputs (not shown), both types of inputs being directly routed to the microprocessor. Two analog inputs 66 and 68 are further provided for connecting a given pressure transducer 54 to the circuit board 42. In this manner, in operation, the circuit board 42 receives, at any time, a signal from the installed pressure transducer 54 connected thereto and subsequently processes and compares the received signal to adjusted pressure values in order to selectively start or stop the pump driver (reference 14 in FIG. 1).

Still referring to FIG. 4 and FIG. 5, there is in particular provided a first input 66 for enabling connection of a pressure transducer 54 having a 0-5V rating to the circuit board 42, and a second input 68 for alternatively enabling connection of a pressure transducer 54 having a 0-100 mV rating to the circuit board 42. The inputs 66 and 68 may also be used to accommodate other types of pressure transducers as in 54 available on the market, such as pressure transducers as in 54 having a 0-10V rating, a 4-20 mA rating, or ratiometric pressure sensors (none shown). When it is desired to accommodate voltage (or current) pressure transducers as in 54, the first analog input, illustratively input 66, is implemented as a conventional operational amplifier circuit (not shown) consisting of a filter and a follower circuit to match the impedance at the input to the circuit board 42. The LMV932™ model from National Semiconductor may for example be used for this purpose. Alternatively, in order to accommodate ratiometric sensors, the second analog input, illustratively input 68, is implemented as amplificatory circuitry having filters integrated therewith to cut external noise (none shown). The AD623™ and the INA122™ models from National Semiconductor may for example be used.

Still referring to FIG. 4 and FIG. 5, the jockey pump controller 18 illustratively operates by associating the selector switch (reference 36 in FIG. 2) with the pressure transducer 54 and may allow setting of specific time delays in starting and stopping the pump driver (reference 14 in FIG. 1) using built-in timers (not shown). The selector switch 36 has three (3) positions, namely the HAND, OFF, and AUTO positions, with the jockey pump controller 18 starting and stopping the jockey pump (reference 16 in FIG. 1) according to pressure limits programmed using the UP/DOWN buttons as in 64 when the selector switch 36 is in the AUTO position. For this purpose, the microprocessor built into the circuit board 42 constantly monitors the pressure of the piping system as in 22, such a pressure being preferably between a predetermined start pressure (hereinafter the Cut-in pressure) and a predetermined stop pressure (hereinafter the Cut-out pressure).

Still referring to FIG. 4 and FIG. 5, the Cut-out pressure is illustratively set by moving the corresponding upper DIP switch 58 to the ON position (e.g. by moving the DIP switch 58 from left to right) and setting the value of the Cut-out pressure on the display 56 using the UP/DOWN buttons as in 64. Once the pressure has been set to the desired value, the DIP switch 58 can be switched to the OFF position. The Cut-in pressure is set in a similar manner such that the latter is less than the Cut-out pressure, with a difference as low as a 1 pounds per square inch (PSI) being achievable with such precise adjustments. The jockey pump controller 18 illustratively prevents incorrect programming of the pressure threshold by making it impossible to set a value of the Cut-in pressure above that of the Cut-out pressure, and vice versa. As such, it is preferable to set the value of the Cut-out pressure before setting that of the Cut-in pressure.

Still referring to FIG. 4 and FIG. 5, the DIP switches as in 58 illustratively have additional parameters associated therewith, such as “Unit”, “On timer” and “Off timer”, which can therefore be adjusted in a similar manner to the Cut-in pressure (“Cut-in”) and Cut-out pressure (“Cut-out”). Illustratively, the pressure unit can be selected as desired among PSI, bar, kilopascal (KPA), high of water column expressed in feet, or high of water column expressed in meter. It is therefore possible to for instance provide a jockey pump controller 18 having a dual PSI and KPA scale for various applications and markets.

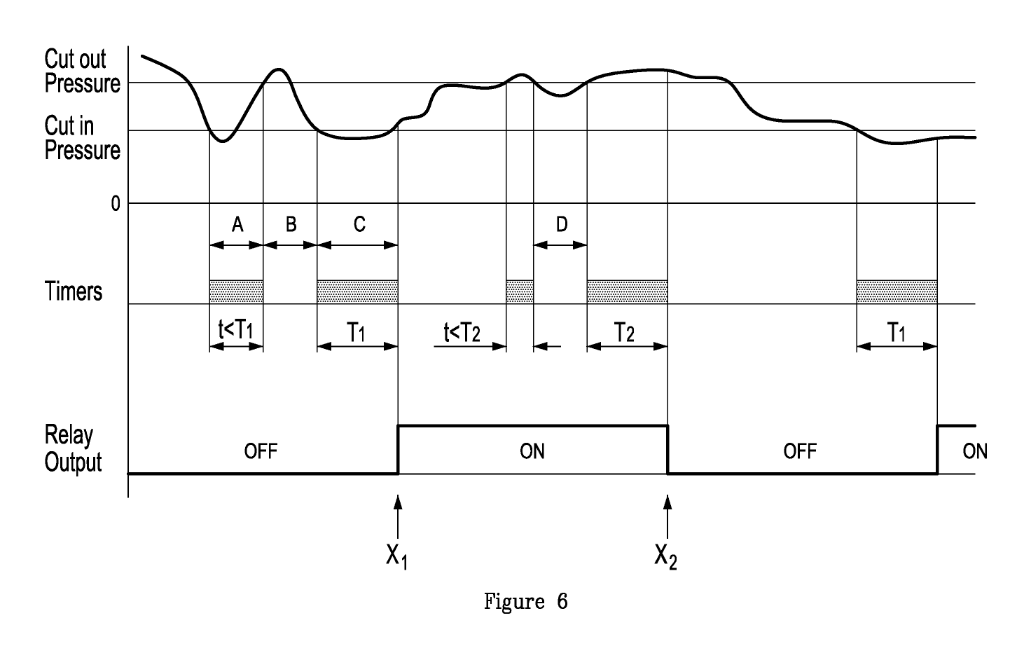

Referring now to FIG. 6, when the selector switch (reference 36 in FIG. 2) is in the AUTO position, the jockey pump controller (reference 18 in FIG. 1) thus starts and stops the jockey pump (reference 16 in FIG. 1) according to the pressure limits programmed using the UP/DOWN buttons as in 64. As the pressure drops below the Cut-in pressure (segment A), the internal On-Timer (not shown) begins counting the preset on-time delay T₁. If the pressure drop is not steady and pressure increases above the Cut-out pressure before expiry of the on-time delay T₁ (segment B), the timer is set to zero and will not resume counting until the pressure drops under the Cut-in pressure (segment C). Once the on-time delay T₁ ends, the relay output, which is fed to the jockey pump 16 for running the latter, is energized (i.e. moved from OFF to ON) at X₁, thus activating the jockey pump 16. The relay output is subsequently de-energized (i.e. moved from ON to OFF) at X₂, thus stopping the jockey pump 16 once the Cut-out pressure is achieved and the off-time delay T₂ from the internal off-timer has expired. If the pressure were to drop below the Cut-out pressure before expiration of the off-time delay T₂, the timer is reset to zero and will not begin counting until the pressure level reaches the Cut-out pressure once again (segment D).

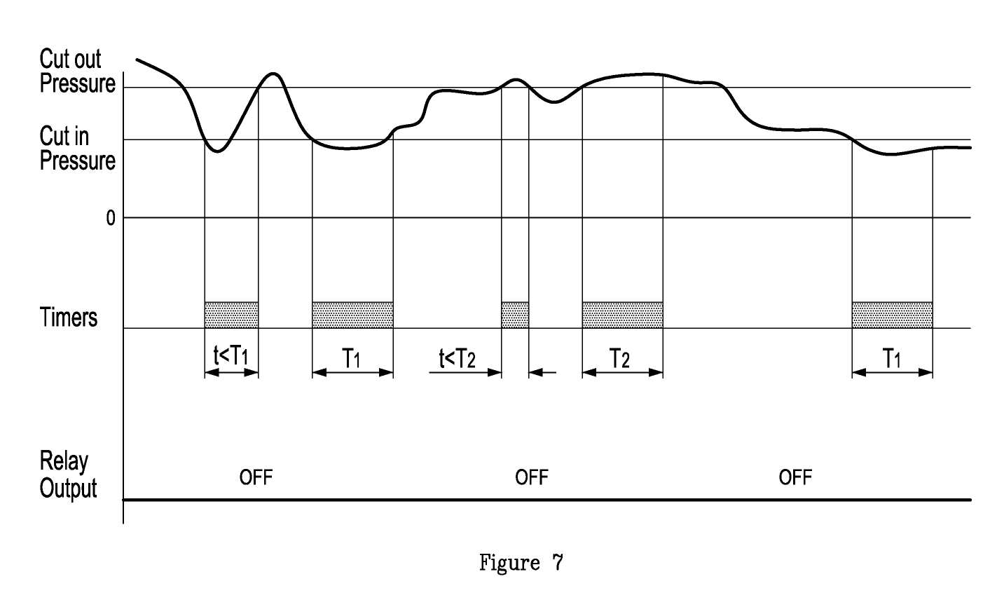

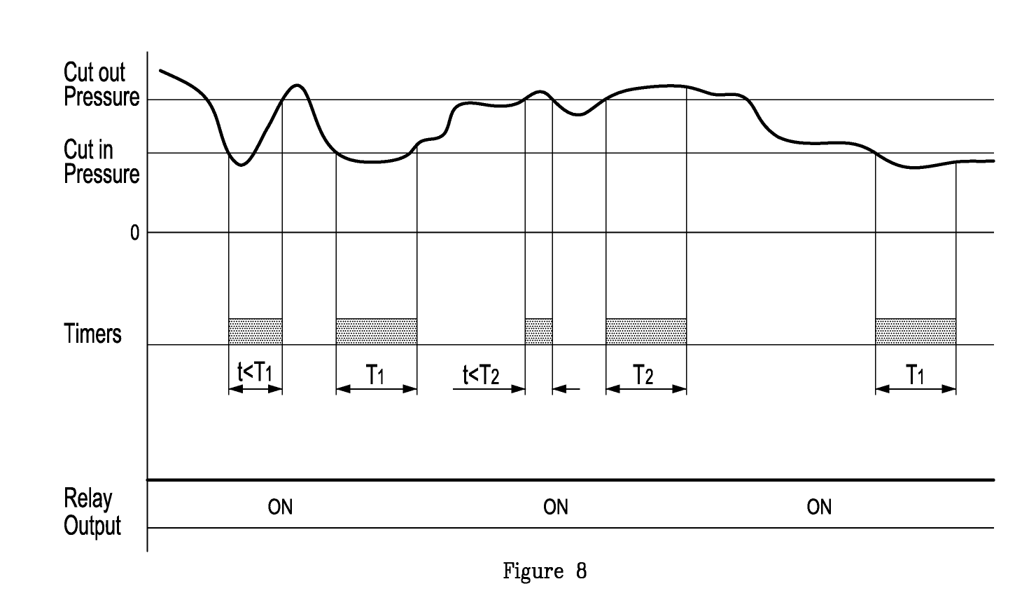

Referring now to FIG. 7 and FIG. 8, alternatively, when the selector switch (reference 36 in FIG. 2) is in the OFF position, the jockey pump controller (reference 18 in FIG. 1) stops the jockey pump (reference 16 in FIG. 1) regardless of whether the pressure within the fire pump system (reference 10 in FIG. 1) is above or below the Cut-in or Cut-out pressures and of whether the on-time and off-time delays T₁ and T₂ have expired (see FIG. 7). When the selector switch 36 is in the HAND position, the jockey pump controller 18 instead runs the jockey pump 16 continuously regardless of the pressure within the fire pump system 10 (see FIG. 8). By providing fully independent Cut-in and Cut-out threshold setting points, pressure adjustments exhibiting large differences are advantageously prevented and it then becomes possible to start and stop the fire pump 12 exactly when desired. As a result, potential overpressure in the system (reference 10 in FIG. 1) is overcome and an accurate monitoring of the pressure therewithin can be achieved whether the selector switch 36 is in the AUTO, OFF or HAND positions.

Referring back to FIG. 5, the circuit board 42 further has mounted thereon a plurality of (e.g. four (4)) light emitting diodes (LEDs) as in 70 for enabling operators to visualize within which range the actual pressure within the fire pump system (reference 10 in FIG. 1) is, especially when different pressure units are selected, such pressure level resulting from operation of the jockey pump (reference 16 in FIG. 1) and associated jockey pump controller (reference 18 in FIG. 1) described herein above. In the present illustrative embodiment, three (3) LEDs as in 70, illustratively green, white and red, are driven by digital outputs of the circuit board 42 to indicate the pressure range. The green LED 70 illustratively shines steadily when the pressure is above the Cut-out set point. The white LED 70 illustratively shines when the pressure is between the Cut-in and the Cut-out set points. The red LED 70 remains ON as long as the pressure is below the Cut-in set point. The remaining LED 70, which is positioned adjacent to the relay output (not shown), is illustratively green and shines steadily at the same time as the output relay is activated. It then becomes easy for an operator to visually verify and monitor the pressure settings of the fire pump assembly (reference 10 in FIG. 1), thus simplifying interaction with the operator. Failures of the system 10 are also less likely to go unnoticed as data, such as pressure levels and settings, is made readily available to the operator on a continuous basis, thus improving the overall reliability and performance of the system 10.

Referring back to FIG. 1, the microprocessor based jockey pump controller 18 thus advantageously improves the performance of the overall system 10 as compared to conventional jockey pump controllers, which use pressure switches instead of pressure transducers. Indeed and as mentioned herein above, more accurate pressure readings are achieved by the controller 18 as a whole unit, thus simplifying the installation, pressure adjustments, and starting up of the overall fire pump system 10. Moreover, a plurality of functions can be brought together in a single device, namely the populated circuit board 42, thus further increasing the reliability of the system 10.

Although the present invention has been described hereinabove by way of specific embodiments thereof, it can be modified, without departing from the spirit and nature of the subject invention as defined in the appended claims.

1. A microprocessor based jockey pump controller for controlling operation of a jockey pump used to maintain pressure within a fire pump system, the controller comprising:
an electronic circuit board having a microprocessor mounted thereon; and
a solid state pressure sensing device for monitoring a current level of the pressure, said sensing device connected to said board for transmitting to said microprocessor an electrical signal indicative of said current level of the pressure;
wherein said microprocessor compares said received signal to predetermined pressure thresholds for selectively starting or stopping the jockey pump.

2. A microprocessor based jockey pump controller for controlling operation of a jockey pump used to maintain pressure within a fire pump system, the controller comprising:
an electronic circuit board having a microprocessor mounted thereon;
a solid state pressure sensing device for monitoring a current level of the pressure, said sensing device connected to said board for transmitting to said microprocessor an electrical signal indicative of said current level of the pressure, wherein said microprocessor compares said received signal to predetermined pressure thresholds for selectively starting or stopping the jockey pump;
a first visual indicator for displaying said current level of the pressure; and
a second visual indicator for displaying said predetermined pressure thresholds.
